(19) United States
(12) Patent Application Publication
(10) Pub. No.: US 2013/0040792 A1
(43) Pub. Date: Feb. 14, 2013

(54) EQUIPMENT FOR THE EXCHANGE OF REPLACEABLE COMPONENTS IN MACHINE TOOLS

(71) Applicants: Jon Arana Gárate, Eibar (Guipuzcoa) (ES); Patxi Eceiza Agote, Zarautz (Guipuzcoa) (ES)

(72) Inventors: Jon Arana Gárate, Eibar (Guipuzcoa) (ES); Patxi Eceiza Agote, Zarautz (Guipuzcoa) (ES)

(73) Assignee: GMTK Multi-Process Machining, S.A., Arroa-Behekoa, Zestoa (Guipúzcoa) (ES)

(21) Appl. No.: 13/579,736

(22) PCT Filed: Feb. 18, 2010
(86) PCT No.: PCT/ES10/00070

§ 371 Date: Nov. 1, 2012

(51) Int. Cl. B23Q 3/155

(52) U.S. Cl. 483/16

(57) ABSTRACT

Equipment for the exchange of replaceable components in machine tools, specifically replaceable components of different categories, necessary for different machining operations, such as heads or tool holders and tools, including a unified static storage, in which the components are located, and a single piece of manipulator equipment provided with at least one manipulator for the components, automated and controlled by a control system, for the movement, exchange and positioning of the replaceable components of both types between the shaft of the machine tool and the storage.

### OBJECTS OF THE INVENTION

The present invention, equipment for the exchange of replaceable components in machine tools relates, as the title indicates, to equipment for the automatic exchange of different components of different categories (heads, tool holders and tools) in machine tools. The purpose of the equipment is to allow, in a machine tool for example a vertical lathe or the like, the exchange of replaceable components of various categories therein, whether they are heads, tool holders or tools, for which said equipment essentially comprises a unified static storage, where all the replaceable components of the different categories are stored, and a single piece of manipulator equipment for said components automated and controlled by a control system, which is provided with freedom of movements and has at least one manipulator with gripping means suitable for gripping said replaceable components of different categories, such that said manipulator is capable of the movement, exchange and positioning thereof between the main axis or shaft of the machine tool and the mentioned storage.

The field of application of the present invention is comprised within the technical sector of the industry dedicated to manufacturing machine tools, as well as equipment, machines and devices for the change of heads, tool holders and replaceable tools in machine tools.

### BACKGROUND OF THE INVENTION

In the state of the art, equipment is known for the exchange of tools in machine tools in which the manipulator and the gripping means for gripping the components to be replaced are formed such that they can only carry out the change of a replaceable component of a single category, i.e., tools or heads or tool holders.

In the state of the art, manipulator equipment or robots are known which, by means of two clamps, exclusively jaw and transport tools from a storage to the main axis or shaft of a machine tool and vice versa, their application being limited solely to the change of tools. This fact involves a drawback since in many machine tools it is necessary to not only carry out the change of tools for performing different operations, but it is also necessary to carry out the change of the head or tool holder, which operations must be performed automatically by means of other independent equipment or manually, with the consequent loss of time that this involves.

Likewise it is worth mentioning that the most used and known systems in the current state of the art for the exchange of tools in machines for vertical machining are the following:

Circular rotary pick-up hung from the crossbeam of the machine: It is a common system in high vertical machining lathes incorporated by many manufacturers and has the advantage of being accessible from any position of the crossbeam, regardless of the height of the part, it has short runs for changing heads and allows combining heads with tools, when the tools are scarce. However, it has the drawback that it involves large weights hung from the crossbeam, which causes its torsion and, consequently, the loss of precision of the machine; it has weight limitations for heavy heads, as well as a limitation in the number of heads, because the more there are, the larger is the necessary diameter, whereby a larger crossbeam is required. Furthermore, when it is necessary to store and change a medium number of tools, other vertical carrousel type independent equipment is required.

Circular rotary pick-up on the floor: It is a common system in small turning heights. It has the advantage of not having a limitation in the number of heads, because the diameter thereof is not limiting; nor does it have a weight limitation for heavy heads and it allows combining heads with tools, when there are few of them. However, it has the drawback that the pick-up may not be accessible from any position of the crossbeam when the height of the part in the machining process is greater than the course of the shaft; when it is necessary to store and change a large number of tools, it requires other vertical carrousel type independent equipment; the runs are long for changing heads, the change times being increased and the floor space easement is large when there are many heads.

Horizontal rotary carrousel on the floor: This system has the advantage of not being limited in the number of heads and allowing the combination of heads and many tools, however it requires an intermediate manipulator for heads and tool holders. Furthermore, in high turning machines, in order for it to be accessible from any position, it is necessary to greatly raise the structure on which the carrousel is supported such that the pick-up cannot be accessible from any position of the crossbeam when the height of the part in the machining process is greater than the course of the shaft. It has limitations for the heads of a large weight and a large floor space easement.

Circular rotary pick-up on the floor with raising: This system has the advantage of being accessible from any position of the crossbeam and allows combining heads with tools when there are few of them, however, it has the drawback that when it is necessary to store and change a large number of tools, it requires other vertical carrousel type independent equipment. Furthermore, in high machines, for changing in the highest positions of the crossbeam, a large disc raising course is necessary, therefore the weight of the heads and tools stored therein are limited.

Carriage with translational movement on the floor: This system has the advantage of not having a limitation regarding the number of heads or regarding the weight thereof, however it may not be accessible from any position of the crossbeam when the height of the part in the machining process is greater than the course of the shaft and, furthermore, other vertical carrousel type independent equipment is required for tools, involving a large floor space easement when there are many heads.

Stationary pick-ups on the floor, independent for each head: This system has no limitation in the number of heads, in weight and it has a relatively low manufacturing cost, but it has the drawbacks that it requires an additional shaft for the head to move to each of the pick-ups, it may furthermore not be accessible from any position of the crossbeam when the height of the part in the machining process is greater than the course of the shaft. It requires independent equipment for tools, it has a large space easement and has longer runs for changing heads which worsen the change times.

Fixed shelf and intermediate column-manipulator: This system has the advantage that the columnn acts as a robot and can change in any position of the machine, without limitation in the number of heads and the runs being short. However, the manufacturing cost is relatively high, it has a very large floor space easement when there are many heads and the maximum head weight for the manipulator is limited.

Therefore, an objective of the present invention is to provide to the state of the art a single piece of equipment for the movement, exchange and positioning of replaceable components of different categories in a machine tool, heads, tool holders as well as tools, in which the advantages of the known systems are incorporated and the aforementioned drawbacks are prevented, it being necessary to point out that the applicant does not know of the existence of any equipment having technical, structural and constituent characteristics similar to those of the equipment which is described in the present application.

### DESCRIPTION OF THE INVENTION

The equipment for the change of replaceable components of different categories thus allows carrying out not only the change of tools in a machine tool, but it also performs the change of heads or tool holders, when it is necessary.

Likewise, the equipment of the invention is advantageously capable of carrying out the change or replacement of tools in the same action or cycle of the manipulator equipment or robot in which the replacement of a head or tool holder is carried out, allowing to reduce the movements and operations of the manipulator equipment and, therefore, the time invested when the replacement of a head is necessary, prior to the change or replacement of one tool or more.

These and other objectives are achieved with the features of the equipment described and claimed herein, which as has been pointed out above essentially comprises one and the same unified static storage in which all the replaceable components are located regardless of their category, a single piece of manipulator equipment or robot ofor said components which is automated and controlled by a control system, and which has at the free end of said manipulator equipment a single manipulator for the movement, exchange and positioning of the replaceable components of different categories between the main axis or shaft of the machine tool and the storage. Both the storage and the manipulator equipment are independent and tight with respect to the machine tool for assuring the precision of all the movements of the manipulator equipment and that the replaceable components located in the storage are not affected by chips being projected from the machine tool which can affect the precision of the machining. Furthermore, the manipulator equipment and the storage are far from the machining area of the machine tool and are specifically located behind the horizontal movement axis of the shaft.

Likewise, the manipulator equipment, located on an independent platform of the machine tool, is placed in an enclosure isolated from the operators while the machine tool is operating, and from said platform the manipulator equipment or robot accesses rotating around a vertical axis or moving longitudinally, allowing the replacement of a tool or head in the single change position in the horizontal movement axis of the shaft, but not in the vertical movement axis. The shaft is accessed by means of the intermediate rigid arms of a fixed length of the manipulator equipment at the free end of which the manipulator is located, which end is opposite the base of the manipulator equipment located in the previous independent platform.

Said manipulator comprises at least one first gripping device for a first category of replaceable components, for example heads or tool holders, and at least one second gripping device for a second category of components, for example, tools.

Said first gripping device has a jaw or yoke with a concave inner cavity and anchoring and gripping means for bracing a component of a first category, i.e., a head or a tool holder, allowing its transport from the main axis or shaft of the machine tool to the storage and vice versa.

Likewise, the second gripping device present in the manipulator has at least one clamp, located on one side of the first gripping device, capable of gripping and transporting a second component category, i.e., tools, from the storage to the machine tool and vice versa. This second gripping device can be double, i.e., it can have two clamps, between which the first gripping device is located.

The concave conformation of the first gripping device also has anchoring and gripping means for the head or tool holder, which are located in the concave contour of the mentioned conformation or in an position adjacent to said contour. These anchoring and gripping means can consist, for example, of fixed pivots and/or of retractable pawls or pivots protruding from the manipulator, either from the contour of the conformation or in positions adjacent to said contour.

The components of the first category, i.e., heads or tool holders, have at one of their ends one and the same attaching flange designed to be coupled to the shaft of the machine tool as well as to be gripped and transported by the first gripping device of the manipulator. Said attaching flange has for its coupling, both to the first gripping device as well as to the yokes located in the storage, means complementary to those described above. These replaceable components of first category have characteristics, mainly regarding dimensions and weight, which are completely different from one another and also different from the characteristics of the components of second category, which has caused the manipulation by one and the same piece of manipulator equipment for two categories of replaceable components to have been unviable up until the development of the present equipment.

Likewise, the manipulator also incorporates at least one proximity detector for detecting the presence of any replaceable component, head/tool holder or tool, when it moves closer to the storage, thus preventing possible collisions between the component gripped by the manipulator and a component located in the storage when the manipulator is going to leave a component.

In relation to the unified static storage in which the components of different categories to be replaced are located, it has at least two levels, floors or shelves. At least one of said levels has a preferably circular arc configuration such that they determine a series of housings for receiving vessels where the replaceable components of the second category or tools will subsequently be incorporated.

Likewise, at least one of said levels of the unified storage consists of a platform with side openings which open out towards the side occupied by the manipulator equipment and which are sized to frontally receive and brace a replaceable component of the second category, head or tool holder. These side openings can have retaining means for the replaceable component which they must store, for example, yokes or jaws especially designed for that purpose. The levels with these yokes or jaws will be especially designed for storing heads or tool holders. The jaws which serve as retaining means for the replaceable components of first category in the storage are preferably made up of plates which are fixed on at least one level of the storage and have, from one of their edges, the one which is directed towards the manipulator equipment, a notch sized to brace a replaceable component, this contour being provided with stops or guides or supports, or a combination of any of the above, for gripping said component.

In addition, and to perform the operations for loading and unloading the different categories of components in the storage, the equipment contemplates the existence of a storage loading station, located adjacently thereto and provided with preferably manual rotation means for accessing the isolated enclosure where the platform of the manipulator equipment and the storage are located. Said loading station is equipped with at least one yoke or jaw for locating heads or tool holders and with at least two vessels for housing tools, identical to those incorporated in the storage. By means of the rotation of the loading station, the latter can be manually loaded with the components to be included in the storage from the outside in order to subsequently and after rotating it locate the jaw and the vessels in the isolated enclosure, where the manipulator will be able to take the components from the loading station and transfer them to the storage, and vice versa, when the jaw and vessels of the loading station are empty. The tasks for the preparation of everything necessary for the following machining operations are thus facilitated, since said preparation can be performed while the machine is machining, provided that it does not coincide with a programmed change cycle.

In summary, in this storage loading and unloading station, configured as a rotary structure with preferably manual rotation means, a first position, in which the replaceable components are placed or removed manually therein, and a second position, in which said components can be placed or picked up by the manipulator of the robot from or to the storage, are contemplated.

Therefore, with the described constitution, the equipment of the invention allows carrying out the replacement of tools but also of heads or tool holders in a machine tool, all this such that the manipulator equipment can transport a head or tool holder and one or two tools in the manipulator, the latter case being for the movement of tools from the loading station to the storage and vice versa. The tool and the head or tool holder can be transported in the same operation by the manipulator when it is necessary to replace a head or tool holder, all this by means of a single operation for accessing the manipulator equipment from the storage to the point of replacement of the head or tool holder and of the transported tool.

Furthermore, since there is a single unified storage for the tools and for the heads or tool holders, the runs are shorter for leaving and taking said components in any change, which improves the change times; the manual loading of all the components necessary for any machining operation is facilitated, while the machine works; the accessibility to the heads/tool holders and to the tools for performing maintenance work therein is facilitated and the management and the control of all the components necessary for any machining operation are facilitated.

In addition, the existence of a single manipulator for changing heads or tool holders and tools has a great advantage over conventional equipment which requires two independent pieces of equipment, since an intermediate manipulator for heads or tool holders is not necessary, the necessary movements of the manipulator equipment and thus the times of change are reduced, using a single management software, implemented in a control system, the probability of failures is reduced, since the number of necessary actions and manoeuvring signals is smaller, furthermore facilitating the maintenance of the assembly.

Other advantages of the equipment worth mentioning is the fact that the heads or tool holders are accessible for change from any position of the crossbeam, also in high turning machines, there being no limitation in the number or in the weight of heads or tool holders and tools, nor a large floor space easement.

It is also worth mentioning that the equipment contemplates the tightness with respect to the machining area of the machine tool, which closure assures the absence of chips on the heads or tool holders or tools, a very common drawback in other solutions and which entails unwanted effects in the machining, particularly since said chips in the components of first category, heads or tool holders, require a systematic cleaning before each change since the existence of chips has repercussions on the lack of repeatability in the coupling of the head or tool holder to the shaft of the machine, detracting from the precision of the obtained machinings.

Finally, the joint location of the unified storage and of the manipulator equipment on the same side of the machine tool allows freeing up the space of the opposite side for part palletising systems and other auxiliary systems, which has great difficulties in most of the solutions used in the state of the art since it is necessary to use this space therein. Furthermore, the fact that the manipulator equipment and the storage are located on the same side allows shortening the crossbeam on which the shaft of the machine moves horizontally on the opposite side to where the manipulator equipment is located. This allows having a lighter crossbeam which facilitates the vertical movement thereof as well as reducing its manufacturing cost.

The operation process of the equipment for the change optimises the movements of the manipulator equipment between the storage and the shaft of the machine tool, such that when it replaces from the shaft the head or tool holder and the tool located therein, the method followed for the change can consist of:
the manipulator in a single movement picks up the replaceable component of a second category or tool and subsequently the component of a first category, head or tool holder, from the shaft of the machine tool,
said manipulator moves to the storage and deposits the head or tool holder and subsequently the tool in its position,
said manipulator takes a new tool and subsequently a new head or tool holder from the storage, and finally
said manipulator couples the head or tool holder and subsequently the tool in the shaft of the machine.

It is worth mentioning that between each change of a replaceable component for another component, the head or tool holder located in the shaft of the machine tool must always be in its change position, i.e., in its single change position in the horizontal movement axis of the shaft, but not in the vertical movement axis thereof, and the orientation of the tool must always be the same according to the characteristics of the head or of the tool holder.

### DESCRIPTION OF THE DRAWINGS

To complement the present description and for the purpose of aiding to better understand the features of the invention, a set of drawings is attached as an integral part thereof, in which the following has been depicted with an illustrative and non-limiting character:

FIG. 1 shows a perspective view of a machine tool with the equipment object of the present invention.

FIG. 2 shows a plan view of an embodiment of equipment for the change of replaceable components in machine tools, according to the invention, in which it has been depicted with the manipulator equipment or robot positioned for taking the component or components to be replaced from the storage, the main parts and elements comprised in said equipment being observed therein.

FIG. 3 shows a view similar to FIG. 1, with the manipulator equipment positioned for coupling and/or picking up a replaceable component from the machine tool.

FIG. 4 shows a perspective view of the manipulator with which the manipulator equipment is provided which includes the equipment of the invention, the different retaining elements which it has both for tools and for heads or tool holders being observed.

FIG. 5 shows a possible structure of the storage and platform which supports the manipulator equipment of the invention depicted in FIGS. 1 and 2.

FIG. 6 shows a perspective view of one of the yokes or jaws provided in some of the levels of the storage for housing and retaining components of the first category, i.e., heads or tool holders.

FIG. 7 shows a detail of the loading and unloading station for loading and unloading the components in the storage.

FIG. 8 shows a detail of a vessel for depositing the tool and a tool.

### PREFERRED EMBODIMENT OF THE INVENTION

In view of the mentioned figures, and according to the numbering adopted, a preferred embodiment of the invention can be observed therein, which comprises the parts and elements which are indicated and described in detail below.

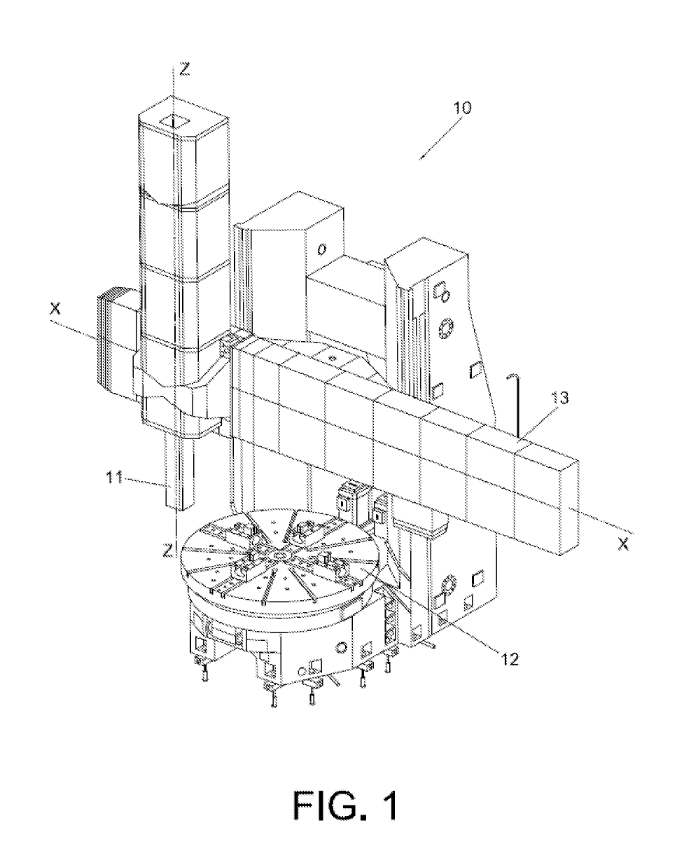

Thus, as shown in FIGS. 1 to 3, the equipment for the change of replaceable components in machine tools which is described comprises a unified storage (40) and manipulator equipment (20) by means of which the change of replaceable components of the different categories, heads or tool holders and tools, will be carried out, both the storage (40) and the manipulator equipment (20) being independent and tight with respect to the machine tool (10), there furthermore being a loading and unloading station (30) for said components on one of the sides of said storage (40). Said manipulator equipment (20), with a constitution known in itself, will have a series of degrees of freedom of movements, sufficient to perform the different operations for replacing the replaceable components of the machine tool (10). Said machine tool (10) has, among other components, a main axis or shaft (11) which moves vertically, a horizontal crossbeam (13) along which the shaft (11) moves horizontally and a machining area (12) where the part to be machined is located.

Both the storage (40) and the manipulator equipment (20) are independent and tight with respect to the machine tool (10) for assuring the precision of all the movements of the manipulator equipment (20) and that the replaceable components (80, 90) located in the storage (40) are not affected by chips being projected from the machining area (12) of the machine tool (10) which can affect the precision of the machining. Furthermore, the manipulator equipment (20) and the storage (40) are far from the machining area (12) of the machine tool (10) and are specifically located behind the horizontal movement axis (X axis) of the shaft (11).

The storage (40) can have one or more levels (43, 45) for placing the two categories (80, 90) of components to be replaced, whereas the manipulator equipment (20) will be provided with a series of degrees of freedom of movement which allow it to access the different replaceable components located in said storage (40), and transport them to the position where these components must be assembled in the shaft (11) of the machine tool (10) and vice versa, or to the loading and unloading station (30) in order to locate them in the storage (40) or vice versa. Said change position of components in the shaft (11) is a single one in the horizontal movement axis thereof (11), X axis, but not in the vertical movement axis thereof, Z axis.

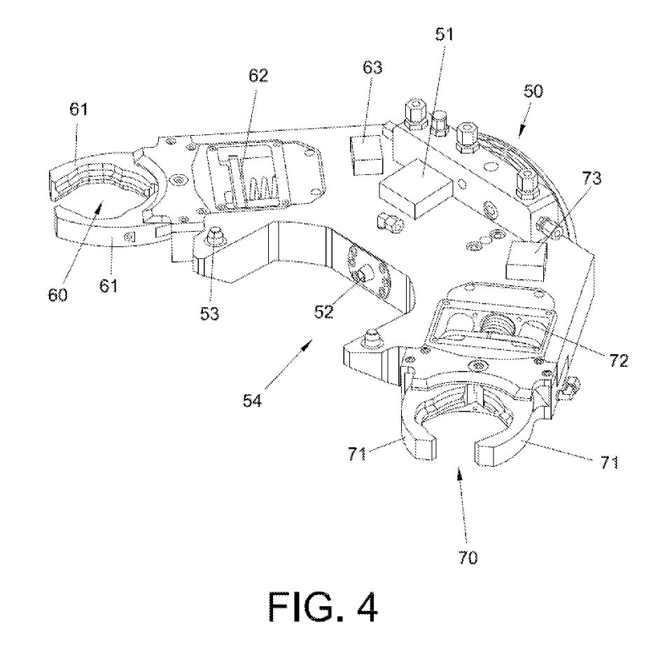

In order to perform the operations for gripping and transporting the components to be replaced from the storage (40) to the machine tool (10) and from said machine tool (10) to the storage (40), as well as from the loading and unloading station (30) to the storage (40) and vice versa, the manipulator equipment or robot (20) has at least one manipulator (50), which is shown in a perspective view in FIG. 4, which has a first gripping device (54) for a first category of replaceable components, such as the heads and tool holders (80) and a second gripping device (60, 70) for a second category of components.

Said second gripping device (60, 70) is formed by two clamps (60, 70), the arms (61, 71) of which can be opened and closed by different mechanisms (62, 72), mainly a combination of a hydraulic system and springs, although other known systems such as hydraulic or pneumatic cylinders, springs, electromagnetic actuators, or a combination of the above, among others, could also be used. The manipulator (50) will be connected in an articulated manner to the free end of the manipulator equipment (20) as well as to the corresponding control and power supply sources, said clamps (61, 71) being intended for gripping components of the second category, i.e., tools (90).

Likewise, the first gripping device (54), located between the mentioned clamps (60 and 70) is formed in the depicted example by an intermediate conformation (54), which is sized to brace a replaceable head or tool holder (80) of a machine tool (10), i.e., suitable for the replaceable components of first category. This conformation (54) has anchoring and gripping means for the head or tool holder (80) which it must transport, which means can consist of, for example, fixed pivots (53) and/or retractable pivots (52), located in coincidence with the contour of the conformation (54) or arranged in an position adjacent to said contour.

The manipulator (50) is equipped with proximity detectors (51, 63, 73) installed in each of the clamps (60, 70) as well as in the grip for heads or tool holders made up of the intermediate conformation (54), being intended for detecting the unexpected presence of components in the storage (40) and preventing possible collisions when the manipulator (50) moves closer to said storage (40) in order to deposit a component of any category.

The components of the first category, i.e., heads or tool holders (80), have at one of their ends one and the same attaching flange designed to be coupled to the shaft (11) of the machine tool (10) as well as to be gripped and transported in the intermediate conformation (54). Said attaching flange has for its coupling, both to the intermediate conformation (54) with fixed pivots (53) and/or retractable pivots (52) as well as to the yokes (42) located in the storage, means complementary to those described above.

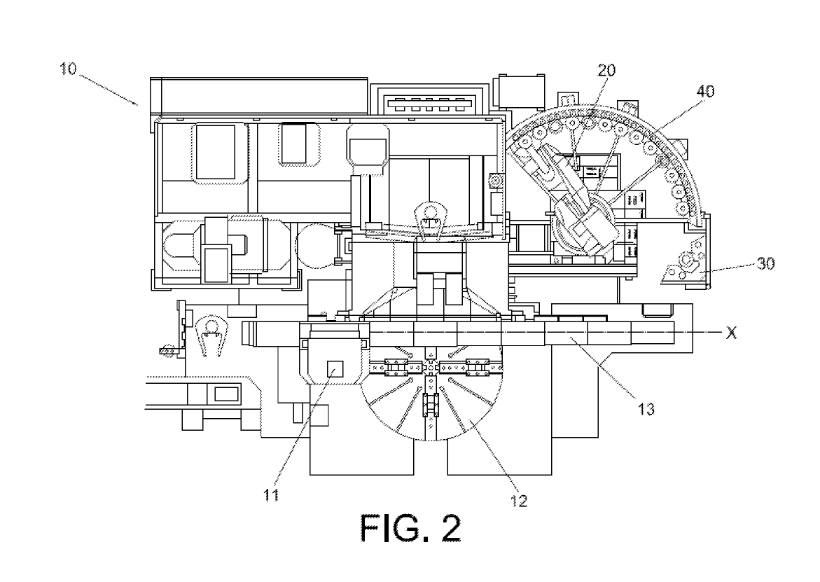

Due to the constitution of the manipulator (50), according to the invention, to start operating, the manipulator equipment (20) can pick up from the storage (40), in the situation of FIG. 2, a first tool holder or head (80), through the conformation (54) of the manipulator, and a first tool (90) by means of the clamps (60 or 70), moving this assembly to the shaft (11) of the machine tool (10) in which it will perform, on the main axis or shaft (11) thereof, firstly the placement of the first head or tool holder (80) and then the placement of the first tool (90) picked up from the storage (40). Once the use of that first tool (90) has ended, and after the manipulator (50) has returned to the storage (40) to pick up a second tool, assuming that the first head (80) is maintained, the manipulator (50) removes the first tool (90) from the shaft (11) and then places the second tool picked up from the storage (40) last of all. It then removes the first tool (90) to the storage (40). If in the following work step of the machine (10) it is necessary to change both the tool and the head or tool holder, the manipulator (50) removes the second tool and the first head or tool holder (80) from the shaft (11), and after leaving them in the storage (40), it picks up therefrom a second head or tool holder and a new tool which it places in the shaft of the machine.

In summary, the particular process for the change of replaceable components of two categories would be the following:
the manipulator (50) of the manipulator equipment (20), in one and the same movement, picks up a replaceable component of second category i.e., a tool (90), and subsequently a component of second category, i.e., a head or tool holder (80), from the shaft (11) of the machine tool (10),,
said manipulator (50) moves to the storage (40) and deposits the head or tool holder (80) and subsequently the tool (90) in the corresponding position,
said manipulator (50) takes a new component of each category, i.e., one of head or tool holder type and one of tool type, from the storage (40),
and finally, said manipulator (50) couples the tool holder or head component and subsequently the tool type component in the shaft (11) of the machine tool (10).

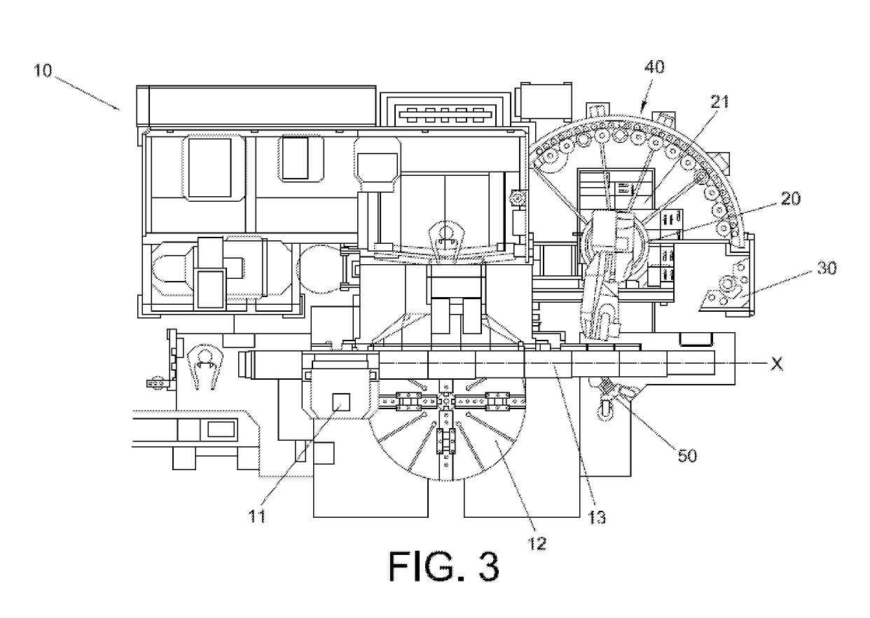

FIG. 2 shows the manipulator equipment (20) in the position of access to the storage (40) for picking up a head or tool holder, if necessary, and a tool, which components it will move to the shaft (11) of the machine tool (10), FIG. 3, for the replacement or change of other replaceable components.

The manipulator equipment (20), for the movements between the storage (40), the loading and unloading station (30) and the machine tool (10) can require a rotational movement around a vertical axis or a movement along a horizontal path.

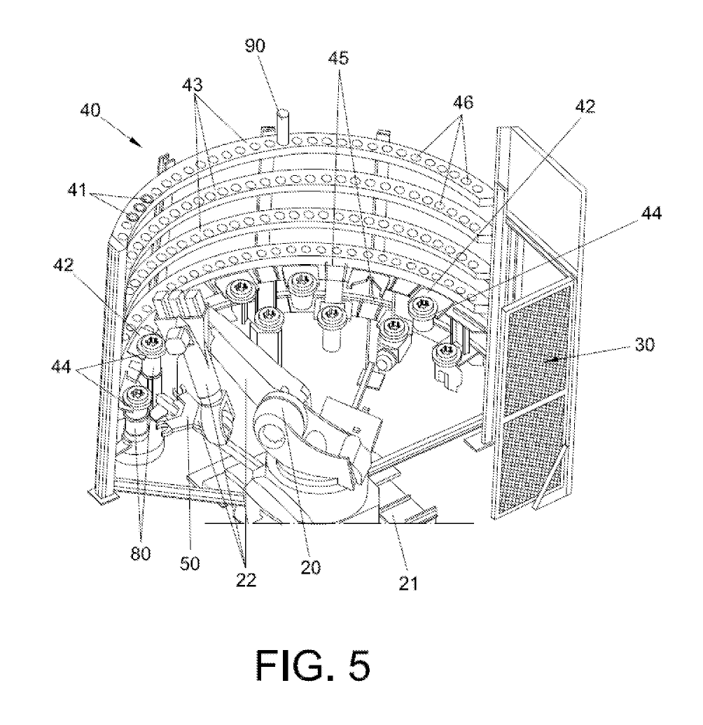

In the first case, i.e., in which it only requires the rotation, it has been provided that the manipulator equipment (20) is assembled on a platform (21) independent from the machine (10), as shown in FIG. 5, and is connected to the storage (40) by means of rigid arms (22) of a fixed length.

Furthermore, in said FIG. 5 it can be seen how the storage (40), in a preferred embodiment of the invention, is made up of several levels (43), preferably with a circular arc configuration, part of which have housings (46) in which, arranged inside tool holder vessels (41), the tools (90) forming one of the types of replaceable components in the machine tool (10) will be located.

Furthermore, one or more of the levels of the storage (40), which have been referenced with number 45 to distinguish them, have side openings (44) which open out towards the side occupied by the manipulator equipment (20) and which are sized to frontally receive and brace the other category of replaceable components, i.e., a head or tool holder (80).

Thus, as observed in the embodiment shown in FIG. 5, the levels (43) with housings (46) will preferably be intended to receive and store tools (90), whereas the side openings (44) will be intended to receive heads or tool holders (90).

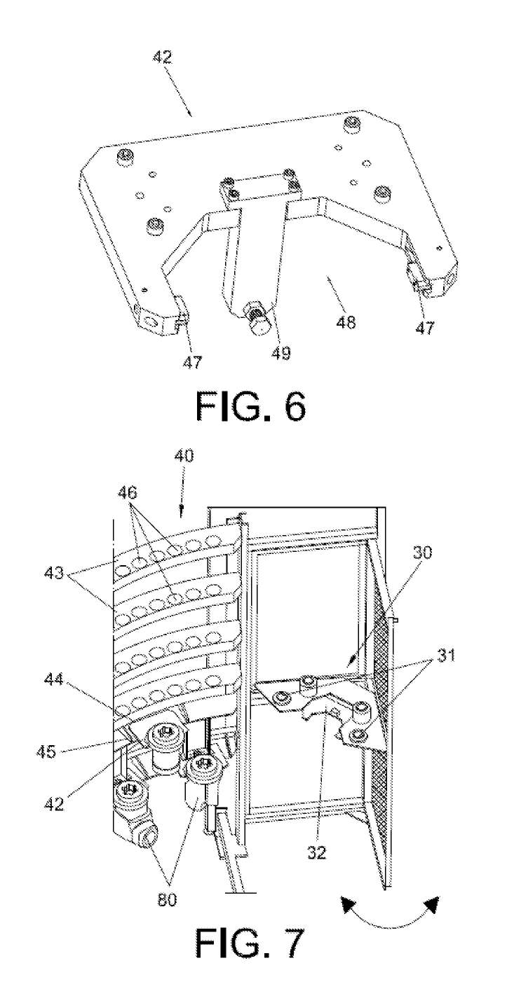

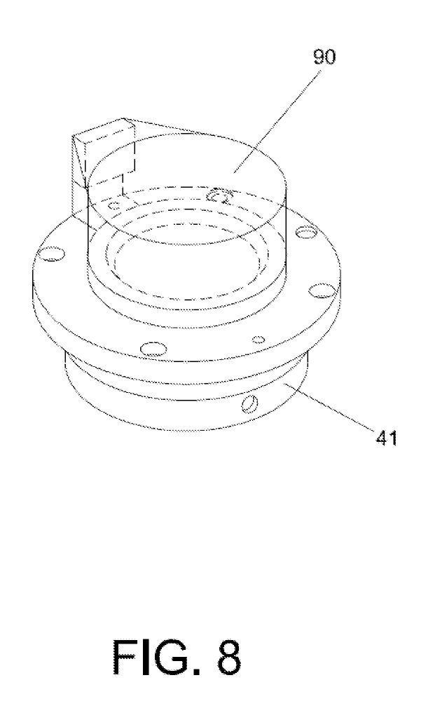

Furthermore, the existence of yokes or jaws (42) is contemplated in the mentioned side openings (44), which yokes or jaws, as shown in FIG. 6, are made up of a considerably flat body having, from one of its edges, a notch (48) for receiving and bracing a replaceable component of the machine tool, especially a head or tool holder (80). Said notch (48) of the jaw or yoke (42) in turn has stops and supports (49) adapted to each replaceable component and guides (47) which will serve for positioning in a precise and repetitive manner, as well as means for gripping and retaining the component.

As has been indicated above, the manipulator equipment (20) will have the degrees of freedom of movements necessary for carrying out all the operations in the storage (40), in the loading and unloading station (30), as well as in the machine tool (10) and the movement between them in one direction or the other.

Therefore, to perform the operations for loading and unloading replaceable components, the loading and unloading station (30), located as has been mentioned adjacently to the storage (40), as shown in FIG. 7, is a rotary structure provided with preferably manual rotation means, which is equipped with at least one yoke or jaw (32) for locating head or tool holder (80) type components and with several tool holder vessels (31), identical to those incorporated in the storage (40), for housing tool (90) type components. Thus, in this loading and unloading station (30) a first position, in which the replaceable components are placed or removed manually, and a second position, in which said components are placed or picked up by the manipulator (50) of the manipulator equipment (20) from or to the storage (40), are contemplated.

Finally, it must be pointed out that the equipment for the change of replaceable components in machine tools contemplates the use of a program with a code legible and/or executable by means of elements integrated in a control system which allows optimally managing the operations and movements of the manipulator equipment or robot (20) as well of the manipulator (50), for the purpose of moving, exchanging and positioning the replaceable components of different types between the shaft (11) of the machine tool (10) and the storage (40) as well as between the storage (40) and the loading and unloading station (30).

Having sufficiently described the nature of the present invention, as well as the way of putting it into practice, it is not considered necessary to further extend its description for any person skilled in the art to understand its scope and the advantages derived therefrom, stating that, within its essence, it may be put into practice in other embodiments which differ in detail from the one indicated by way of example, and which are also covered by the protection which is sought provided that its fundamental principle is not altered,

1-16. (canceled)

17. Equipment for the change in machine tools with a ram of replaceable components of different categories, such as heads or tool holders and tools, necessary for different machining operations, characterised in that it comprises a single unified single static storage in which all the replaceable components are located regardless of their category, and a single piece of manipulating equipment for said components, automated and controlled by a control system, said manipulating equipment having a single manipulator for the movement, exchange and positioning of the replaceable components of any of the different categories between the ram of the machine tool and the storage, said manipulator comprising at least two different gripping devices, one first gripping device for a first category of replaceable components and at least one second gripping device for a second category of components, wherein the first category of replaceable components are heads or tool holders and the second category of replaceable components are tools.

18. The equipment according to claim 17, characterised in that the first gripping device has a jaw or yoke with a concave inner cavity and anchoring and gripping means.

19. The equipment according to claim 17, characterised in that the second gripping device has at least one clamp by the first gripping device.

20. The equipment according to claim 19, characterised in that the manipulator has a clamp on both sides of the first gripping device.

21. The equipment according to claim 17, characterised in that the first and/or the second device have at least one device for detecting the unexpected presence of a replaceable component to prevent possible collisions when positioning a component in the storage.

22. The equipment according to claim 18, characterised in that the anchoring and gripping means consist of at least one fixed or retractable pin located in the body of the jaw.

23. The equipment according to claim 17, characterised in that the manipulating equipment is arranged on an independent platform of the machine tool and is connected with the storage by means of rigid intermediate arms of a fixed length which have the manipulator at their free end.

24. The equipment according to claim 17, characterised in that the single storage has at least one height or level with concave openings for frontally receiving and bracing a replaceable component of first category.

25. The equipment according to claim 24, characterised in that the retaining means for the replaceable components of first category consist of a jaw arranged in each opening, said jaw having guiding, gripping and support means for said replaceable component.

26. The equipment according to claim 25, characterised in that said jaws have a flat configuration, being supported and fixed on at least one height of the storage, coinciding with the openings thereof, having from one of their edges a notch sized to brace a replaceable component, from the contour of which stops for gripping and guiding said component protrude.

27. The equipment according to claim 17, characterised in that it has a single exchange station for loading and unloading said replaceable components in the storage, said station having rotation means between a first position in which the replaceable components are manually placed in said station and a second position in which the replaceable components are placed or removed from said single station by means of the manipulating equipment.

28. The equipment according to claim 17, characterised in that the storage and the manipulating equipment are independent and tight with respect to the machine tool.

29. The equipment according to claim 17, characterised in that the storage and the manipulating equipment are located on a side of the machining area and behind the horizontal movement axis (X axis) of the ram of said machine, i.e., on the side opposite that of the machining area.

30. The equipment, according to claim 17, characterised in that it comprises at least a second manipulator.

31. A method for the change of two replaceable components of two different categories, between heads, tool holders or tools, of the ram of a machine tool, by means of equipment according to claim 17 wherein the first category of replaceable components are heads or tool holders and the second category of replaceable components are tools, characterised in that,
the manipulator in a single movement picks up a replaceable component of a second category and subsequently of a first category from the ram of the machine tool,
said manipulator moves to the storage and deposits the component of first category and subsequently the component of second category in its position,
said manipulator takes a new component of second category and subsequently a new component of first category from the storage, and
said manipulator couples the component of first category and subsequently the component of second category in the ram of the machine.

32. A computer program for the change in machine tools of replaceable components of different categories, such as heads or tool holders and tools, characterised in that it allows carrying out the operations of the method according to claim 31.
